(19) United States
(12) Patent Application Publication
(10) Pub. No.: US 2025/0266205 A1
(43) Pub. Date: Aug. 21, 2025

(54) INDUCTOR, COIL SUBSTRATE, AND METHOD OF MANUFACTURING INDUCTOR

(71) Applicant: Panasonic Intellectual Property Management Co., Ltd., Osaka (JP)

(72) Inventor: Toshiyuki ASAHI, Osaka (JP)

(21) Appl. No.: 18/857,400

(22) PCT Filed: Mar. 16, 2023
(86) PCT No.: PCT/JP2023/010405

§ 371 Date: Oct. 16, 2024

(30) Foreign Application Priority Data
Apr. 20, 2022 (JP) 2022-069636

(51) Int. Cl. H01F 27/28; H01F 27/32; H01F 41/04

(52) U.S. Cl. CPC H01F 27/2804; H01F 27/323; H01F 41/041

(57) ABSTRACT

A coil substrate includes: a substrate; a first wiring on a first main surface of the substrate; a second wiring on a second main surface of the substrate; a first insulator covering the first wiring; and a second insulator covering the second wiring. The first wiring includes a first coil portion wound outward from one end, and a first connection portion drawn out from the other end of the first coil portion and connected to a first electrode. The second wiring includes a second coil portion wound outward from one end, and a second connection portion drawn out from the other end of the second coil portion and connected to a second electrode. Respective innermost peripheries of the first coil portion and the second coil portion coincide over the whole circumference, and respective outermost peripheries of the first coil portion and the second coil portion coincide over the whole circumference.

### CROSS-REFERENCE OF RELATED APPLICATIONS

This application is the U.S. National Phase under 35 U.S.C. § 371 of International Patent Application No. PCT/JP2023/010405, filed on Mar. 16, 2023, which in turn claims the benefit of Japanese Patent Application No. 2022-069636, filed on Apr. 20, 2022, the entire disclosure of which Applications are incorporated by reference herein.

### TECHNICAL FIELD

The present disclosure relates to an inductor, a substrate, and a method of manufacturing an inductor.

### BACKGROUND ART

A conventionally known inductor includes a substrate, a pair of coil portions provided on the front and back surfaces of the substrate, and a via electrode that passes through the substrate to cause the pair of coil portions to be electrically continuous with each other (see, for example, Patent Literature (PTL) 1).

### CITATION LIST

### Patent Literature

### [PTL 1]

Japanese Unexamined Patent Application Publication No. 2018-117111

### SUMMARY OF INVENTION

### Technical Problem

The present disclosure has an object of providing an inductor, etc. that can suppress deformation of a substrate.

### Solution to Problem

An inductor according to an aspect of the present disclosure is an inductor including: a coil substrate; a magnetic core that contains at least part of the coil substrate; and a first electrode and a second electrode that are connected to the coil substrate, wherein the coil substrate includes: a substrate; a first wiring provided on a first main surface of the substrate; a second wiring provided on a second main surface of the substrate opposite to the first main surface; a first insulator provided on the first main surface and covering the first wiring; and a second insulator provided on the second main surface and covering the second wiring, the first wiring includes a first coil portion wound outward from one end, and a first connection portion drawn out from the other end of the first coil portion and connected to the first electrode, the second wiring includes a second coil portion wound outward from one end, and a second connection portion drawn out from the other end of the second coil portion and connected to the second electrode, the one end of the second coil portion being electrically connected to the one end of the first coil portion, and an innermost periphery of the first coil portion and an innermost periphery of the second coil portion coincide with each other over whole circumference, and an outermost periphery of the first coil portion and an outermost periphery of the second coil portion coincide with each other over whole circumference.

A method of manufacturing an inductor according to an aspect of the present disclosure is a method of manufacturing the above-described inductor, including: forming the first wiring and the second wiring on the first main surface and the second main surface of the substrate respectively; forming the first insulator and the second insulator to cover the first wiring and the second wiring respectively; and forming a through hole in the substrate.

A coil substrate according to an aspect of the present disclosure is a coil substrate that is at least partly contained in a magnetic core in a state of being connected to a first electrode and a second electrode, the coil substrate including: a substrate; a first wiring provided on a first main surface of the substrate; a second wiring provided on a second main surface of the substrate opposite to the first main surface; a first insulator provided on the first main surface and covering the first wiring; and a second insulator provided on the second main surface and covering the second wiring, wherein the first wiring includes a first coil portion wound outward from one end, and a first connection portion drawn out from the other end of the first coil portion and connected to the first electrode, the second wiring includes a second coil portion wound outward from one end, and a second connection portion drawn out from the other end of the second coil portion and connected to the second electrode, the one end of the second coil portion being electrically connected to the one end of the first coil portion, and an innermost periphery of the first coil portion and an innermost periphery of the second coil portion coincide with each other over whole circumference, and an outermost periphery of the first coil portion and an outermost periphery of the second coil portion coincide with each other over whole circumference.

A substrate according to an aspect of the present disclosure is a coil substrate that is connected to a first electrode and a second electrode, the coil substrate including: a substrate; a first wiring provided on a first main surface of the substrate; a second wiring provided on a second main surface of the substrate opposite to the first main surface; a first insulator provided on the first main surface and covering the first wiring; and a second insulator provided on the second main surface and covering the second wiring, wherein the first wiring includes a first coil portion wound outward from one end, and a first connection portion drawn out from the other end of the first coil portion and connected to the first electrode, the second wiring includes a second coil portion wound outward from one end, and a second connection portion drawn out from the other end of the second coil portion and connected to the second electrode, the one end of the second coil portion being electrically connected to the one end of the first coil portion, and an innermost periphery of the first coil portion and an innermost periphery of the second coil portion coincide with each other over whole circumference, and an outermost periphery of the first coil portion and an outermost periphery of the second coil portion coincide with each other over whole circumference.

### Advantageous Effects of Invention

According to the present disclosure, it is possible to provide an inductor, etc. that can suppress deformation of a substrate.

### BRIEF DESCRIPTION OF DRAWINGS

FIG. 1 is a perspective view of inductor 10 according to an embodiment.

FIG. 2 is a perspective view of a coil substrate according to the embodiment.

FIG. 3 is a perspective view of the coil substrate according to the embodiment excluding a first insulator and a second insulator.

FIG. 4 is an explanatory diagram illustrating the planar shapes of first wiring and second wiring according to the embodiment.

FIG. 5 is an explanatory diagram illustrating a method of manufacturing an inductor by a first technique according to the embodiment.

FIG. 6 is an explanatory diagram illustrating the method of manufacturing an inductor by the first technique according to the embodiment.

FIG. 7 is an explanatory diagram illustrating the method of manufacturing an inductor by the first technique according to the embodiment.

FIG. 8 is an explanatory diagram illustrating a method of manufacturing an inductor by a second technique according to the embodiment.

FIG. 9 is an explanatory diagram illustrating the method of manufacturing an inductor by the second technique according to the embodiment.

FIG. 10 is an explanatory diagram illustrating the method of manufacturing an inductor by the second technique according to the embodiment.

FIG. 11 is an explanatory diagram illustrating the planar shapes of first wiring and second wiring according to Variation 1.

FIG. 12 is an explanatory diagram illustrating the planar shapes of first wiring and second wiring according to Variation 2.

FIG. 13 is an explanatory diagram illustrating the planar shapes of first wiring and second wiring according to Variation 3.

FIG. 14 is an exploded perspective view of an inductor according to Variation 4.

FIG. 15 is a perspective view of the inductor according to Variation 4.

FIG. 16 is a cross-sectional view of an inductor according to Variation 5.

FIG. 17 is a cross-sectional view of an inductor according to Variation 6.

### DESCRIPTION OF EMBODIMENTS

### Inventor's Knowledge

The inventor has found that, in the foregoing conventional inductor, the pair of coil portions do not overlap each other near the via electrode in a plan view of the substrate, which causes the substrate to deform. Specifically, since the pair of coil portions do not overlap each other near the via electrode, the overall linear expansion coefficient of the coil portions varies. Accordingly, when the coil portions are heated due to a temperature rise during the manufacture or use of the inductor, the substrate warps because of variation in overall linear expansion coefficient. The present disclosure is intended to make the overall linear expansion coefficient of the coil portions on the front and back surfaces of the substrate uniform to thereby suppress deformation of the substrate during heating.

### EMBODIMENT

An embodiment will be described in detail below with reference to the drawings. The embodiment described below shows a specific example according to the present disclosure. The numerical values, shapes, materials, structural elements, the arrangement and connection of the structural elements, steps, the order of steps, etc. shown in the embodiment described below are mere examples, and do not limit the scope of the present disclosure. Of the structural elements in the embodiment described below, the structural elements not recited in any one of the independent claims representing the broadest concepts are described as optional structural elements. In the following description, the long-side direction of the inductor is the Y-axis direction, the short-side direction of the inductor is the X-axis direction, and the thickness direction of the inductor is the Z-axis direction.

### [Inductor]

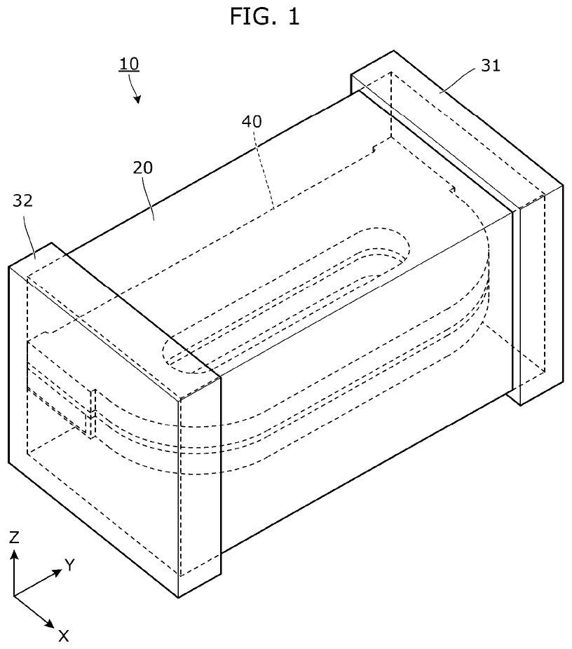

The structure of an inductor according to an embodiment will be described with reference to FIG. 1. FIG. 1 is a perspective view of inductor 10 according to the embodiment.

As illustrated in FIG. 1, inductor 10 includes coil substrate 40, magnetic core 20, first electrode 31, and second electrode 32. Magnetic core 20 is obtained by mixing a magnetic powder and a resin powder and pressure-forming the mixture into a rectangular parallelepiped elongated in the Y-axis direction. Magnetic core 20 contains coil substrate 40.

First electrode 31 and second electrode 32 are formed of conductive members. First electrode 31 is provided at the end of magnetic core 20 on the positive side (i.e. the side indicated by the arrow) in the Y-axis direction, and second electrode 32 is provided at the end of magnetic core 20 on the negative side (i.e. the opposite side to the side indicated by the arrow) in the Y-axis direction.

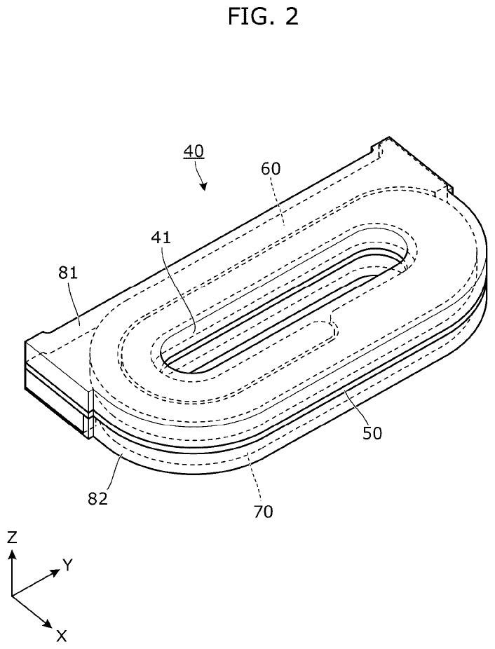

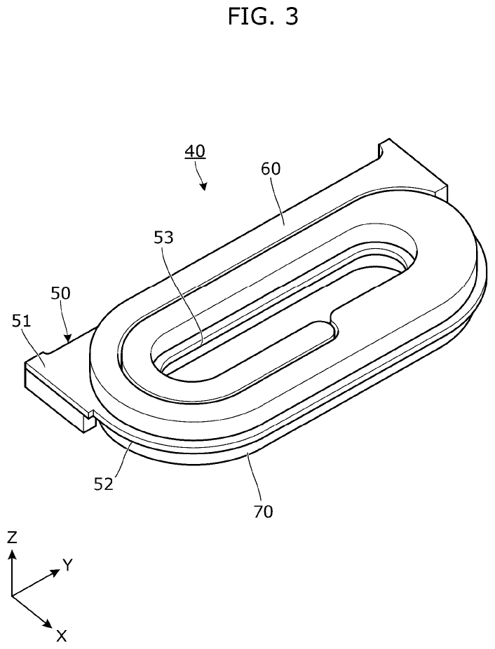

Next, coil substrate 40 will be described in detail. FIG. 2 is a perspective view of coil substrate 40 according to the embodiment. FIG. 2 illustrates inductor 10 in FIG. 1 excluding magnetic core 20, first electrode 31, and second electrode 32. FIG. 3 is a perspective view of coil substrate 40 according to the embodiment excluding first insulator 81 and second insulator 82.

As illustrated in FIGS. 2 and 3, coil substrate 40 includes substrate 50, first wiring 60, second wiring 70, first insulator 81, and second insulator 82, and has, at its center, through hole 41 in the Z-axis direction.

Substrate 50 is, for example, a flexible substrate formed of an insulating film. An example of the material of the insulating film is insulating resin such as polyimide. Substrate 50 may be a glass epoxy substrate. Substrate 50 is a sheet body elongated in the Y-axis direction. The main surface of substrate 50 facing the positive side in the Z-axis direction is first main surface 51, and the main surface of substrate 50 facing the negative side in the Z-axis direction is second main surface 52. Opening 53 is formed through substrate 50 at its center in the Z-axis direction. Opening 53 forms part of through hole 41.

First wiring 60 is provided on first main surface 51 of substrate 50 and electrically connected to first electrode 31. Second wiring 70 is provided on second main surface 52 of substrate 50 and electrically connected to second electrode 32. First wiring 60 and second wiring 70 are formed, for example, of a conductive material such as copper. The specific structures of first wiring 60 and second wiring 70 will be described later.

First insulator 81 is provided on first main surface 51 so as to cover first wiring 60. Second insulator 82 is provided on second main surface 52 so as to cover second wiring 70. First insulator 81 and second insulator 82 are formed, for example, of a solder resist or a coverlay film. The coverlay film is a film obtained by laminating an adhesive layer on one side of an insulating film made of polyimide, for example. First insulator 81 and second insulator 82 have through hole 41.

### [First Wiring and Second Wiring]

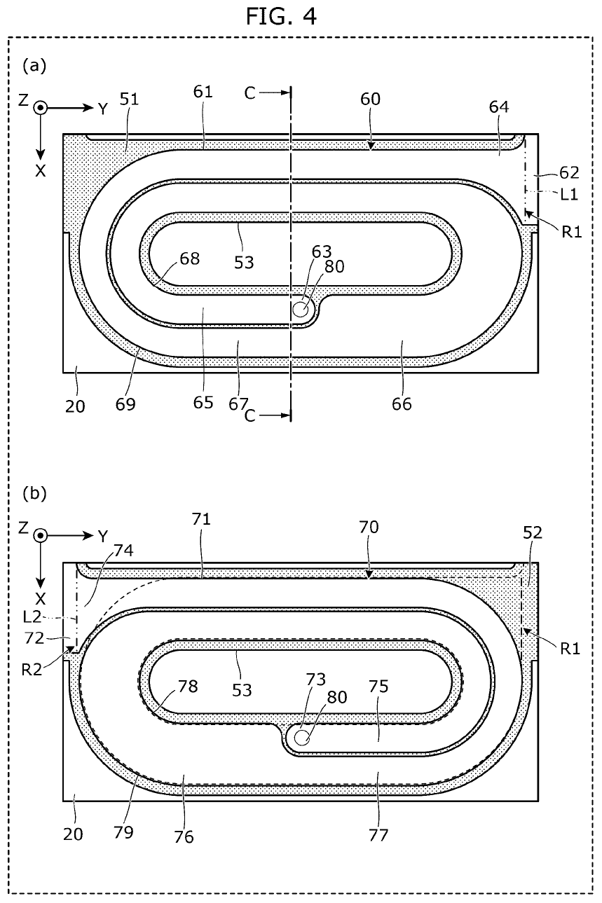

Next, the specific structures of first wiring 60 and second wiring 70 will be described. FIG. 4 is an explanatory diagram illustrating the planar shapes of first wiring 60 and second wiring 70 according to the embodiment. Specifically, (a) in FIG. 4 is a plan view illustrating the planar shape of first wiring 60, and (b) in FIG. 4 is a plan view illustrating the planar shape of second wiring 70. (a) and (b) in FIG. 4 are plan views of first wiring 60 and second wiring 70 as seen from the same direction (the positive side in the Z-axis direction). In FIG. 4, first main surface 51 and second main surface 52 are dot-hatched.

As illustrated in (a) in FIG. 4, first wiring 60 includes wound first coil portion 61 and first connection portion 62 drawn out from first coil portion 61 and electrically connected to first electrode 31. First coil portion 61 has one end 63 at a position on first main surface 51 that is at the center in the Y-axis direction and is closer to the positive side in the X-axis direction than the center in the X-axis direction. First coil portion 61 is wound clockwise outward from one end 63. The number of turns of first coil portion 61 is approximately 1 and ¾ turns. The other end 64 of first coil portion 61 is located at the end of first main surface 51 on the positive side in the Y-axis direction and the negative side in the X-axis direction, and first connection portion 62 is drawn out from the other end 64. The other end 64 has a shape that smoothly widens toward the tip. Boundary L1 between the other end 64 and first connection portion 62 is designated by the dot-dot-dash line. First connection portion 62 has a rectangular shape elongated in the X-axis direction.

In first coil portion 61, the ¾ turn part from one end 63 is narrow portion 65 having a predetermined line width, the ¼ turn part from narrow portion 65 is wide portion 66 larger in line width than narrow portion 65, and the ¾ turn part beyond wide portion 66 from the part overlapping one end 63 to the other end 64 is narrow portion 67 equal in line width to narrow portion 65.

Hence, innermost periphery 68 in first coil portion 61 is composed of the inner peripheral edge of narrow portion 65 and the inner peripheral edge of wide portion 66. Innermost periphery 68 has an oval shape elongated in the Y-axis direction. Opening 53 is located inside innermost periphery 68.

Outermost periphery 69 in first coil portion 61 is composed of the outer peripheral edge of wide portion 66 and the outer peripheral edge of narrow portion 67. Outermost periphery 69 has an oval shape elongated in the Y-axis direction. The contour of first coil portion 61 includes innermost periphery 68, outermost periphery 69, and boundary L1. This contour is referred to as first coil region R1.

As illustrated in (b) in FIG. 4, second wiring 70 includes wound second coil portion 71 and second connection portion 72 drawn out from second coil portion 71 and electrically connected to second electrode 32. Second coil portion 71 has one end 73 at a position on second main surface 52 that is at the center in the Y-axis direction and is closer to the positive side in the X-axis direction than the center in the X-axis direction. Second coil portion 71 is wound counterclockwise outward from one end 73. The number of turns of second coil portion 71 is approximately 1 and ¾ turns. The other end 74 of second coil portion 71 is located at the end of second main surface 52 on the negative side in the Y-axis direction and the negative side in the X-axis direction, and second connection portion 72 is drawn out from the other end 74. The other end 74 has a shape that smoothly widens toward the tip. Boundary L2 between the other end 74 and second connection portion 72 is designated by the dot-dot-dash line. Second connection portion 72 has a rectangular shape elongated in the X-axis direction.

Via electrode 80 that passes through substrate 50 and is electrically continuous with one end 63 of first coil portion 61 is formed at one end 73 of second coil portion 71. Thus, first coil portion 61 and second coil portion 71 as a whole have a coil shape that is wound counterclockwise from the other end 64 of first coil portion 61.

In second coil portion 71, the ¾ turn part from one end 73 is narrow portion 75 having a predetermined line width, the ¼ turn part from narrow portion 75 is wide portion 76 larger in line width than narrow portion 75, and the ¾ turn part beyond wide portion 76 from the part overlapping one end 73 to the other end 74 is narrow portion 77 equal in line width to narrow portion 75.

Hence, innermost periphery 78 in second coil portion 71 is composed of the inner peripheral edge of narrow portion 75 and the inner peripheral edge of wide portion 76. Innermost periphery 78 has an oval shape elongated in the Y-axis direction. Opening 53 is located inside innermost periphery 78.

Outermost periphery 79 in second coil portion 71 is composed of the outer peripheral edge of wide portion 76 and the outer peripheral edge of narrow portion 77. Outermost periphery 79 has an oval shape elongated in the Y-axis direction. The contour of second coil portion 71 includes innermost periphery 78, outermost periphery 79, and boundary L2. This contour is referred to as second coil region R2. In (b) in FIG. 4, first coil region R1 of first wiring 60 is designated by the dash lines.

As illustrated in (b) in FIG. 4, innermost periphery 68 of first wiring 60 and innermost periphery 78 of second wiring 70 coincide with each other over the whole circumference in a plan view (i.e. as seen in the Z-axis direction). Moreover, outermost periphery 69 of first wiring 60 and outermost periphery 79 of second wiring 70 coincide with each other over the whole circumference in a plan view. Since innermost peripheries 68 and 78 coincide with each other over the whole circumference and outermost peripheries 69 and 79 coincide with each other over the whole circumference, the overall linear expansion coefficient of first coil portion 61 and second coil portion 71 is made uniform with little variation. Herein, the expression “coincide with each other over the whole circumference” means that the peripheries coincide with each other preferably by 85% or more of the circumference, more preferably by 90% or more of the circumference, and further preferably by 95% or more of the circumference.

In other words, first coil region R1 and second coil region R2 roughly overlap each other (i.e. coincide with each other) in a plan view. With such relationship, the overall linear expansion coefficient of first coil portion 61 and second coil portion 71 is made uniform with little variation. Specifically, the overlapping rate of first coil region R1 and second coil region R2 is preferably 75% or more, more preferably 80% or more, and further preferably 85% or more.

### [Method of Manufacturing Inductor]

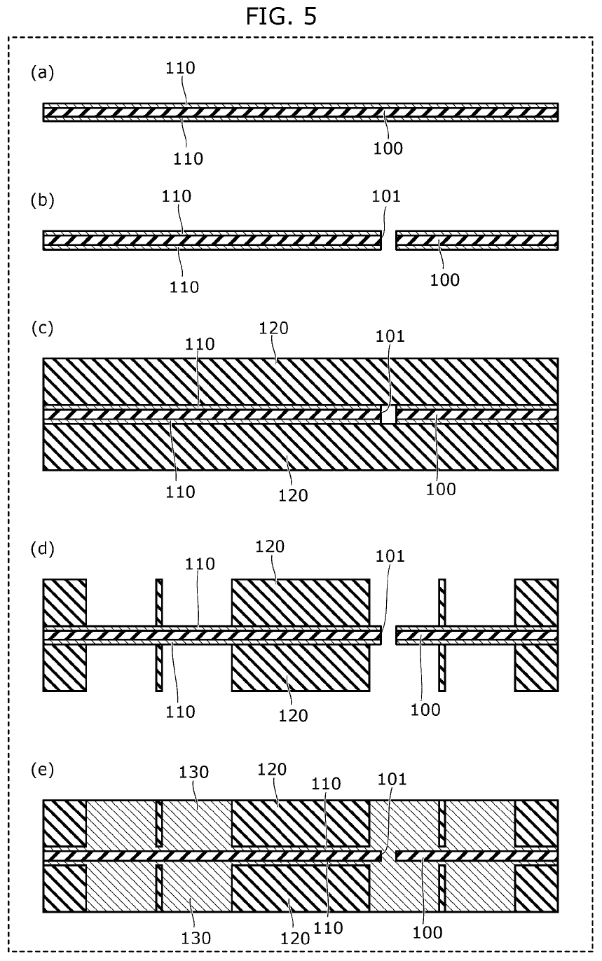

Next, a method of manufacturing inductor 10 will be described. Inductor 10 can be formed by a first technique or a second technique. First, the first technique will be described. FIGS. 5 to 7 are explanatory diagrams illustrating a method of manufacturing inductor 10 by the first technique according to the embodiment. FIGS. 5 to 7 are end views of members during manufacture, corresponding to a cut end surface including line C-C in FIG. 4. In other words, FIGS. 5 to 7 are cross-sectional views of parts corresponding to first coil portion 61 and second coil portion 71.

First, substrate 100 laminated with seed layer 110 on both sides is prepared (see (a) in FIG. 5). Substrate 100 is a member that is to form substrate 50 in inductor 10. Next, through hole 101 is formed through substrate 100 at a position corresponding to via electrode 80 (see (b) in FIG. 5). Through hole 101 is formed, for example, by laser machining or drilling.

Next, resist layer 120 is laminated on each seed layer 110 (see (c) in FIG. 5). Resist layer 120 is formed, for example, using a film or by screen printing. Each resist layer 120 is then exposed and developed to perform patterning with part of resist layer 120 remaining and the other part of resist layer 120 removed (see (d) in FIG. 5).

Next, substrate 100 that has been patterned is electroplated, as a result of which conductive layer 130 made of, for example, copper is formed on both sides of substrate 100 (see (e) in FIG. 5). Conductive layers 130 are integrated with respective seed layers 110.

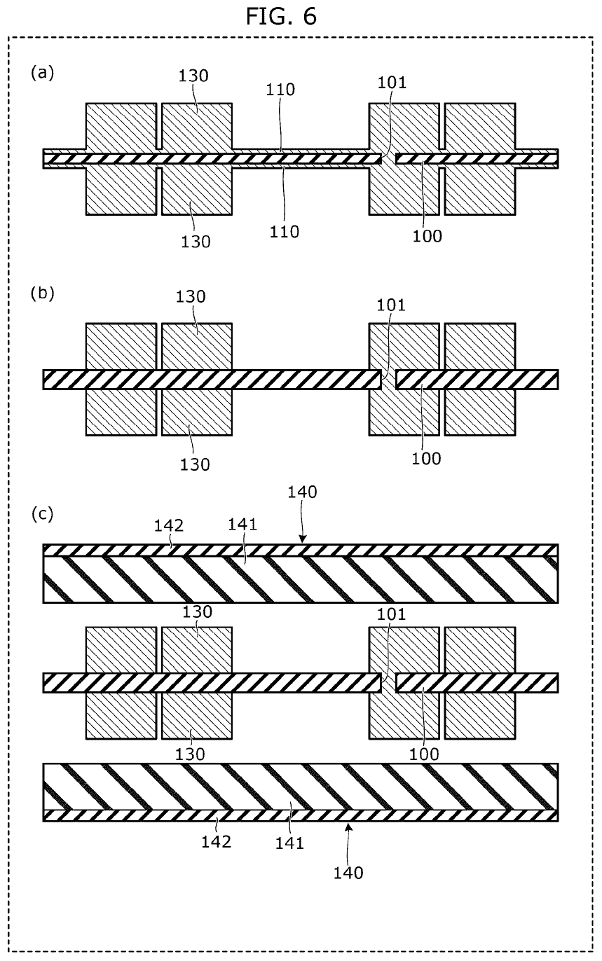

Next, each resist layer 120 is peeled off and removed (see (a) in FIG. 6). After this, each seed layer 110 exposed from conductive layer 130 is removed by flash etching or the like (see (b) in FIG. 6). Respective conductive layers 130 remaining on both sides of substrate 100 form first wiring 60 and second wiring 70 in inductor 10. Thus, first wiring 60 is formed on first main surface 51 of substrate 50 and second wiring 70 is formed on second main surface 52 of substrate 50.

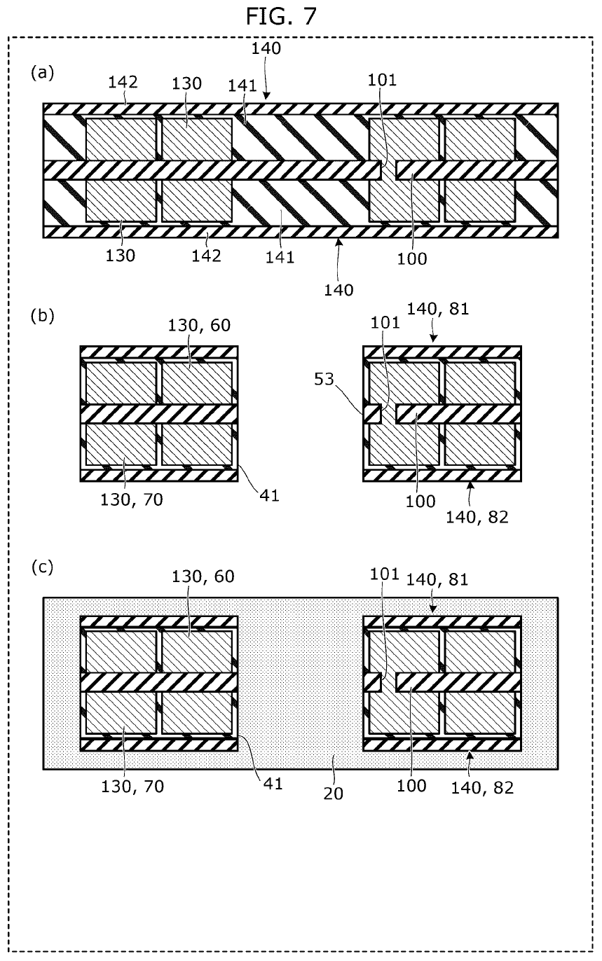

Next, a pair of coverlay films 140 are arranged on both sides of substrate 100 (see (c) in FIG. 6). The pair of coverlay films 140 each have adhesive layer 141 on the substrate 100 side and insulating film 142 on the opposite side to substrate 100. The pair of coverlay films 140 then sandwich substrate 100 to cover first wiring 60 and second wiring 70 (see (a) in FIG. 7). The pair of coverlay films 140 form first insulator 81 and second insulator 82 in inductor 10. Thus, first insulator 81 is formed on first main surface 51 of substrate 50 so as to cover first wiring 60, and second insulator 82 is formed on second main surface 52 of substrate 50 so as to cover second wiring 70. For example, the thickness of first insulator 81 directly above first wiring 60 (thickness in the Z-axis direction) is greater than the thickness of first insulator 81 between the lines of first wiring 60 (inter-line width). This ensures stable insulation. The same applies to second insulator 82.

Next, the pair of coverlay films 140 and substrate 100 are holed together to form through hole 41 through substrate 100 at its center. Through hole 41 is formed by laser machining or punching (see (b) in FIG. 7). Through hole 41 is formed through the center (region inside innermost periphery 68) of first coil portion 61 of first wiring 60 and the center (region inside innermost periphery 78) of second coil portion 71 of second wiring 70.

Next, a magnetic powder and a resin powder are mixed and pressure-formed into magnetic core 20 that covers first insulator 81 and second insulator 82 (see (c) in FIG. 7). Inductor 10 illustrated in FIG. 1 is thus formed.

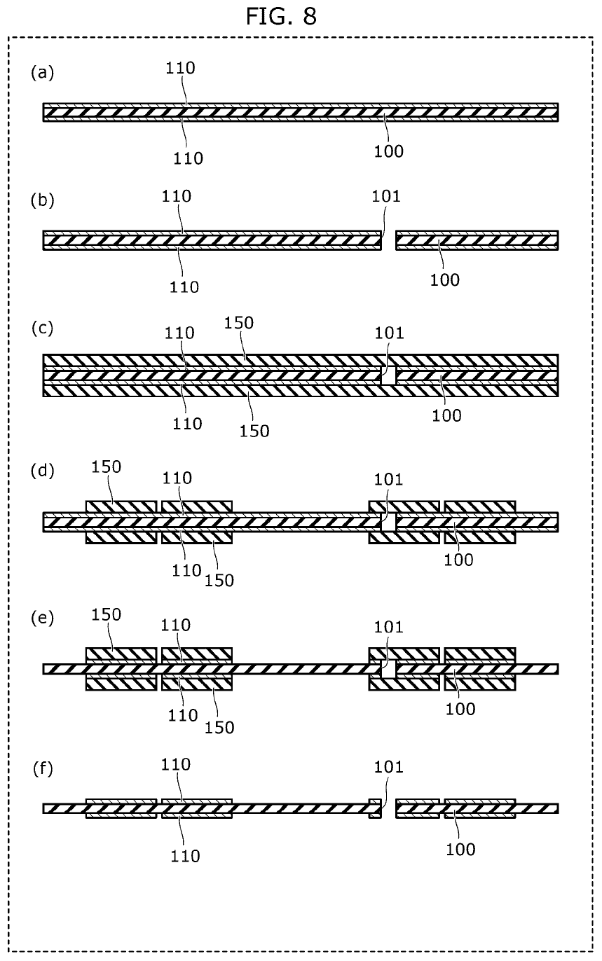

Next, the second technique will be described. FIGS. 8 to 10 are explanatory diagrams illustrating a method of manufacturing inductor 10 by the second technique according to the embodiment.

First, substrate 100 laminated with seed layer 110 on both sides is prepared (see (a) in FIG. 8). Substrate 100 is a member that is to form substrate 50 in inductor 10. Next, through hole 101 is formed through substrate 100 at a position corresponding to via electrode 80 (see (b) in FIG. 8). Through hole 101 is formed, for example, by laser machining or drilling.

Next, resist layer 150 is laminated on each seed layer 110 (see (c) in FIG. 8). Resist layer 150 is formed, for example, using a film or by screen printing. Resist layer 150 is thinner than resist layer 120 formed in the first technique.

Each resist layer 150 is then exposed and developed to perform patterning with part of resist layer 150 remaining and the other part of resist layer 150 removed (see (d) in FIG. 8). Substrate 100 that has been patterned is then etched to remove seed layer 110 exposed from resist layer 150 (see (e) in FIG. 8).

Next, each resist layer 150 is peeled off and removed (see (f) in FIG. 8). This exposes seed layer 110 covered with resist layer 150.

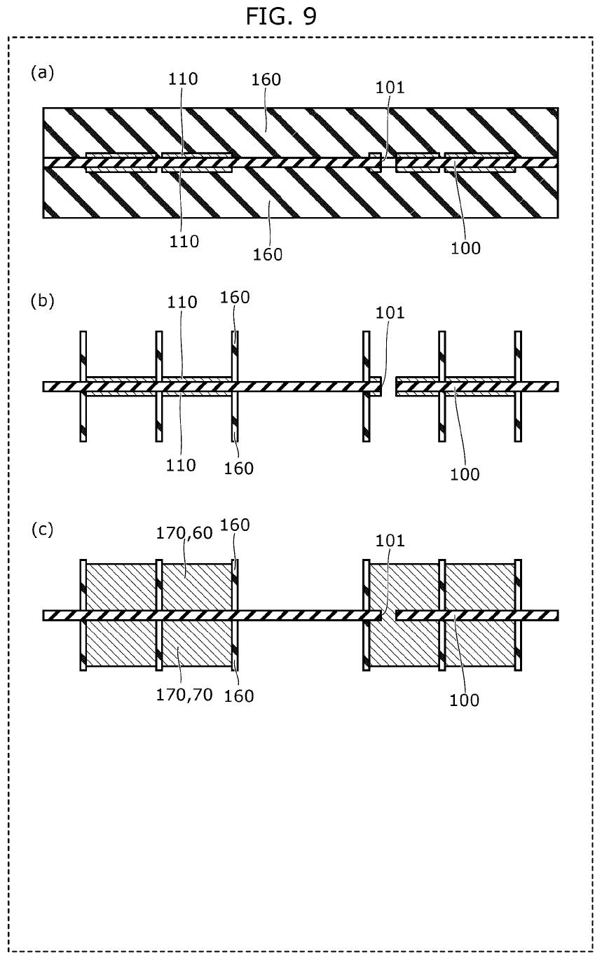

Next, resist layer 160 is laminated on both sides of substrate 100 (see (a) in FIG. 9). Resist layer 160 is formed, for example, using a film or by screen printing. Resist layer 160 is thicker than resist layer 150.

Each resist layer 160 is then exposed and developed to perform patterning with part of resist layer 160 remaining and the other part of resist layer 160 removed (see (b) in FIG. 9). This exposes seed layer 110.

Next, substrate 100 that has been patterned is electroplated, as a result of which conductive layer 170 made of, for example, copper is formed (see (c) in FIG. 9). Here, conductive layers 170 are integrated with respective seed layers 110 to form first wiring 60 and second wiring 70 in inductor 10. Thus, first wiring 60 is formed on first main surface 51 of substrate 50 and second wiring 70 is formed on second main surface 52 of substrate 50.

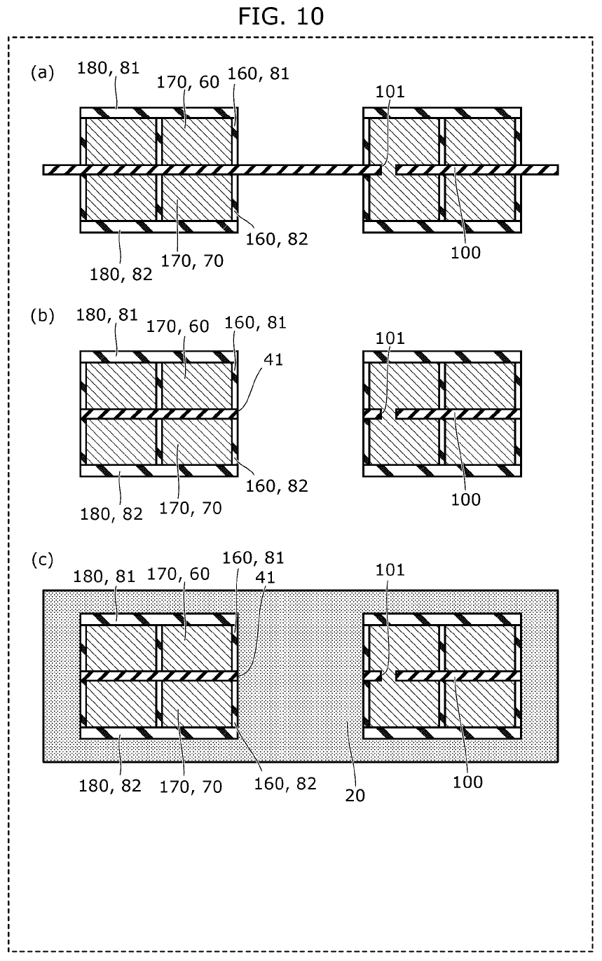

Next, resist layer 180 is formed on each conductive layer 170. As a result, each conductive layer 170 is covered with resist layers 160 and 180 (see (a) in FIG. 10). Resist layers 160 and 180 form first insulator 81 and second insulator 82 in inductor 10. Thus, first insulator 81 is formed on first main surface 51 of substrate 50 so as to cover first wiring 60, and second insulator 82 is formed on second main surface 52 of substrate 50 so as to cover second wiring 70.

Next, through hole 41 is formed through substrate 100 at its center (see (b) in FIG. 10). Through hole 41 is formed by laser machining or punching. Through hole 41 is formed through the center (region inside innermost periphery 68) of first coil portion 61 of first wiring 60 and the center (region inside innermost periphery 78) of second coil portion 71 of second wiring 70.

Next, a magnetic powder and a resin powder are mixed and pressure-formed into magnetic core 20 that covers first insulator 81 and second insulator 82 (see (c) in FIG. 10). Inductor 10 illustrated in FIG. 1 is thus formed.

In both the first technique and the second technique, first wiring 60 and second wiring 70 are formed on both sides of substrate 100 before through hole 41 is formed. Here, if the innermost periphery of the first wiring and the innermost periphery of the second wiring do not coincide with each other over the whole circumference, the strength of the substrate varies. This causes distortion of the substrate during the formation of the through hole, hindering accurate through hole formation. This is noticeable when the through hole is formed by punching.

In this embodiment, innermost periphery 68 of first wiring 60 and innermost periphery 78 of second wiring 70 coincide with each other over the whole circumference. This makes the strength of substrate 100 uniform, and prevents substrate 100 from being distorted during the formation of the through hole. Hence, through hole 41 can be formed accurately.

Particularly in the first technique, the pair of coverlay films 140 and substrate 100 are holed together to form through hole 41. Since distortion of substrate 100 is further suppressed, through hole 41 can be formed more accurately.

### Effects, Etc

As described above, inductor 10 according to the embodiment is an inductor including: coil substrate 40; magnetic core 20 that contains at least part of coil substrate 40; and first electrode 31 and second electrode 32 that are connected to coil substrate 40. Coil substrate 40 includes: substrate 50; first wiring 60 provided on first main surface 51 of substrate 50; second wiring 70 provided on second main surface 52 of substrate 50 opposite to first main surface 51; first insulator 81 provided on first main surface 51 and covering first wiring 60; and second insulator 82 provided on second main surface 52 and covering second wiring 70. First wiring 60 includes first coil portion 61 wound outward from one end 63, and first connection portion 62 drawn out from the other end 64 of first coil portion 61 and connected to first electrode 31. Second wiring 70 includes second coil portion 71 wound outward from one end 73, and second connection portion 72 drawn out from the other end 74 of second coil portion 71 and connected to second electrode 32, one end 73 of second coil portion 71 being electrically connected to one end 63 of first coil portion 61. Innermost periphery 68 of first coil portion 61 and innermost periphery 78 of second coil portion 71 coincide with each other over whole circumference, and outermost periphery 69 of first coil portion 61 and outermost periphery 79 of second coil portion 71 coincide with each other over whole circumference.

A coil substrate according to the embodiment is coil substrate 40 that is at least partly contained in magnetic core 20 in a state of being connected to first electrode 31 and second electrode 32. Coil substrate 40 includes: substrate 50; first wiring 60 provided on first main surface 51 of substrate 50; second wiring 70 provided on second main surface 52 of substrate 50 opposite to first main surface 51; first insulator 81 provided on first main surface 51 and covering first wiring 60; and second insulator 82 provided on second main surface 52 and covering second wiring 70. First wiring 60 includes first coil portion 61 wound outward from one end 63, and first connection portion 62 drawn out from the other end 64 of first coil portion 61 and connected to first electrode 31. Second wiring 70 includes second coil portion 71 wound outward from one end 73, and second connection portion 72 drawn out from the other end 74 of second coil portion 71 and connected to second electrode 32, one end 73 of second coil portion 71 being electrically connected to one end 63 of first coil portion 61. Innermost periphery 68 of first coil portion 61 and innermost periphery 78 of second coil portion 71 coincide with each other over whole circumference, and outermost periphery 69 of first coil portion 61 and outermost periphery 79 of second coil portion 71 coincide with each other over whole circumference.

A coil substrate according to the embodiment is coil substrate 40 that is connected to first electrode 31 and second electrode 32. Coil substrate 40 includes: substrate 50; first wiring 60 provided on first main surface 51 of substrate 50; second wiring 70 provided on second main surface 52 of substrate 50 opposite to first main surface 51; first insulator 81 provided on first main surface 51 and covering first wiring 60; and second insulator 82 provided on second main surface 52 and covering second wiring 70. First wiring 60 includes first coil portion 61 wound outward from one end 63, and first connection portion 62 drawn out from the other end 64 of first coil portion 61 and connected to first electrode 31. Second wiring 70 includes second coil portion 71 wound outward from one end 73, and second connection portion 72 drawn out from the other end 74 of second coil portion 71 and connected to second electrode 32, one end 73 of second coil portion 71 being electrically connected to one end 63 of first coil portion 61. Innermost periphery 68 of first coil portion 61 and innermost periphery 78 of second coil portion 71 coincide with each other over whole circumference, and outermost periphery 69 of first coil portion 61 and outermost periphery 79 of second coil portion 71 coincide with each other over whole circumference.

Since innermost peripheries 68 and 78 coincide with each other over the whole circumference and outermost peripheries 69 and 79 coincide with each other over the whole circumference, the overall linear expansion coefficient of first coil portion 61 and second coil portion 71 is made uniform. Therefore, even if first coil portion 61 and second coil portion 71 are heated due to a temperature rise during the manufacture or use of the inductor, deformation of substrate 50 can be suppressed because the overall linear expansion coefficient of these coil portions is uniform.

In addition, since innermost peripheries 68 and 78 coincide with each other over the whole circumference and outermost peripheries 69 and 79 coincide with each other over the whole circumference and wide portion 66 and wide portion 76 have wide line width, the resistance value can be reduced.

Moreover, substrate 50 is formed of an insulating film.

Since substrate 50 is formed of an insulating film, it is possible to reduce residual stress when forming through hole 41 by punching. Furthermore, given that an insulating film can be made thinner than rigid materials such as glass epoxy, it is possible to improve magnetic properties, reduce the size of inductor 10, and improve workability. In particular, the use of a film made of polyimide as an insulating film can enhance heat resistance.

Moreover, first insulator 81 and second insulator 82 are each formed of a coverlay film.

Since first insulator 81 and second insulator 82 are each formed of a coverlay film, the insulating film of the coverlay film can suppress damage during the formation of through hole 41. Stable insulation properties can thus be achieved.

In addition, since first insulator 81 and second insulator 82 are each formed of a coverlay film, the insulator can be prevented from being damaged by the magnetic material during the formation of magnetic core 20.

A method of manufacturing inductor 10 according to the embodiment includes: forming first wiring 60 and second wiring 70 on both surfaces of substrate 100 (first main surface 51 and second main surface 52 of substrate 50 respectively); forming first insulator 81 and second insulator 82 to cover first wiring 60 and second wiring 70 respectively; and forming through hole 41 in substrate 100.

In this way, first wiring 60 and second wiring 70 are formed on both sides of substrate 100 before the formation of through hole 41, and innermost periphery 68 of first wiring 60 and innermost periphery 78 of second wiring 70 coincide with each other over the whole circumference. This makes the strength of substrate 100 uniform, and prevents substrate 100 from being distorted during the formation of the through hole. Hence, through hole 41 can be formed accurately.

### DESCRIPTION OF VARIATIONS

Variations of the foregoing embodiment will be described below. In the following description, the same parts as those in the foregoing embodiment or other variations are given the same reference signs and their description may be omitted.

### Variation 1

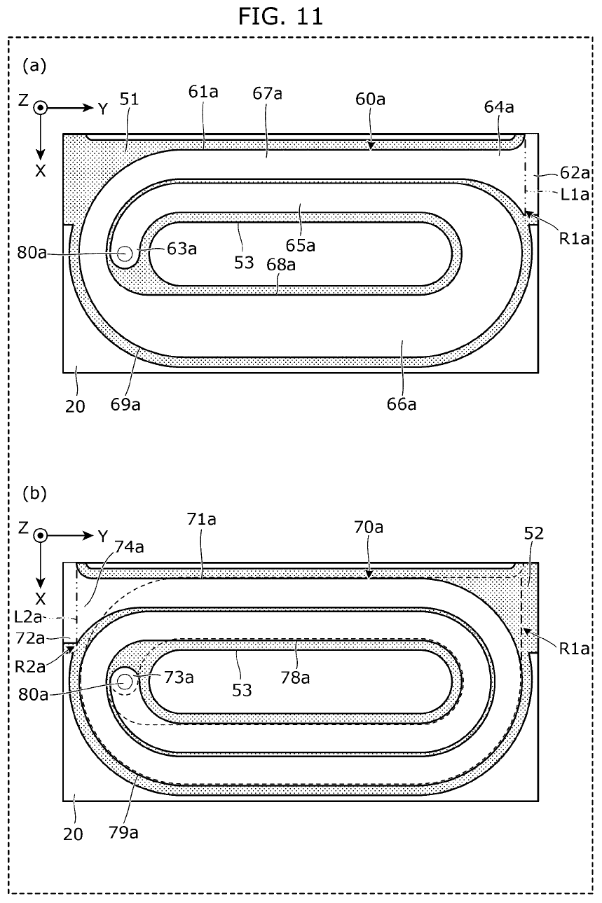

Variation 1 of the foregoing embodiment will be described. Variation 1 differs from the foregoing embodiment in the shapes of the first coil portion and second coil portion. FIG. 11 is an explanatory diagram illustrating the planar shapes of first wiring 60a and second wiring 70a according to Variation 1. FIG. 11 corresponds to FIG. 4.

As illustrated in (a) in FIG. 11, first coil portion 61a in first wiring 60a has one end 63a at a position on first main surface 51 that is at the center in the X-axis direction and is closer to the negative side in the Y-axis direction than the center in the Y-axis direction. First coil portion 61a is wound clockwise outward from one end 63a. The number of turns of first coil portion 61a is approximately 1 and ½ turns. The other end 64a of first coil portion 61a is located at the end of first main surface 51 on the positive side in the Y-axis direction and the negative side in the X-axis direction, and first connection portion 62a is drawn out from the other end 64a. The other end 64a has a shape that smoothly widens toward the tip. Boundary L1a between the other end 64a and first connection portion 62a is designated by the dot-dot-dash line.

In first coil portion 61a, the ⅓ turn part from one end 63a is narrow portion 65a having a predetermined line width, the ⅔ turn part from narrow portion 65a is wide portion 66a larger in line width than narrow portion 65a, and the ½ turn part beyond wide portion 66a from the part overlapping one end 63a to the other end 64a is narrow portion 67a equal in line width to narrow portion 65a.

Hence, innermost periphery 68a in first coil portion 61a is composed of the inner peripheral edge of narrow portion 65a and the inner peripheral edge of wide portion 66a. Outermost periphery 69a in first coil portion 61a is composed of the outer peripheral edge of wide portion 66a and the outer peripheral edge of narrow portion 67a. The contour of first coil portion 61a includes innermost periphery 68a, outermost periphery 69a, and boundary L1a. This contour is referred to as first coil region R1a.

As illustrated in (b) in FIG. 11, second coil portion 71a in second wiring 70a has one end 73a at a position on second main surface 52 that is at the center in the X-axis direction and is closer to the negative side in the Y-axis direction than the center in the Y-axis direction. Second coil portion 71a is wound counterclockwise outward from one end 73a. The number of turns of second coil portion 71a is approximately 1 and ½ turns. The other end 74a of second coil portion 71a is located at the end of second main surface 52 on the negative side in the Y-axis direction and the negative side in the X-axis direction, and second connection portion 72a is drawn out from the other end 74a. The other end 74a has a shape that smoothly widens toward the tip. Boundary L2a between the other end 74a and second connection portion 72a is designated by the dot-dot-dash line.

Via electrode 80a that passes through substrate 50 and is electrically continuous with one end 63a of first coil portion 61a is formed at one end 73a of second coil portion 71a. Thus, first coil portion 61a and second coil portion 71a as a whole have a coil shape that is wound counterclockwise from the other end 64a of first coil portion 61a.

Second coil portion 71a has roughly a uniform line width overall. The contour of second coil portion 71a includes innermost periphery 78a, outermost periphery 79a, and boundary L2a. This contour is referred to as second coil region R2a. In (b) in FIG. 11, first coil region R1a of first wiring 60a is designated by the dash lines.

As illustrated in (b) in FIG. 11, innermost periphery 68a of first wiring 60a and innermost periphery 78a of second wiring 70a coincide with each other over the whole circumference in a plan view (i.e. as seen in the Z-axis direction). Moreover, outermost periphery 69a of first wiring 60a and outermost periphery 79a of second wiring 70a coincide with each other over the whole circumference in a plan view. Since innermost peripheries 68a and 78a coincide with each other over the whole circumference and outermost peripheries 69a and 79a coincide with each other over the whole circumference, the linear expansion coefficient of first coil portion 61a and second coil portion 71a is made uniform.

### Variation 2

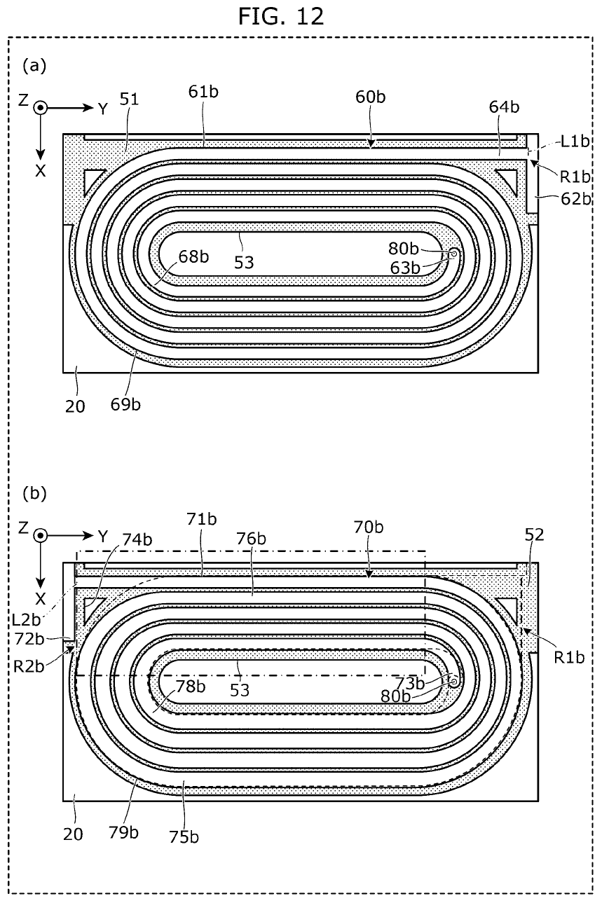

Variation 2 of the foregoing embodiment will be described. Variation 2 differs from the foregoing embodiment and Variation 1 in the shapes of the first coil portion and second coil portion. FIG. 12 is an explanatory diagram illustrating the planar shapes of first wiring 60b and second wiring 70b according to Variation 2. FIG. 12 corresponds to FIG. 4.

As illustrated in (a) in FIG. 12, first coil portion 61b in first wiring 60b has one end 63b at a position on first main surface 51 that is at the center in the X-axis direction and is closer to the positive side in the Y-axis direction than the center in the Y-axis direction. First coil portion 61b is wound clockwise outward from one end 63b. The number of turns of first coil portion 61b is approximately 4 and ¾ turns. The other end 64b of first coil portion 61b is located at the end of first main surface 51 on the positive side in the Y-axis direction and the negative side in the X-axis direction, and first connection portion 62b is drawn out from the other end 64b. Boundary L1b between the other end 64b and first connection portion 62b is designated by the dot-dot-dash line.

First coil portion 61b has roughly a uniform line width overall. The contour of first coil portion 61b includes innermost periphery 68b, outermost periphery 69b, and boundary L1b. This contour is referred to as first coil region R1b.

As illustrated in (b) in FIG. 12, second coil portion 71b in second wiring 70b has one end 73b at a position on second main surface 52 that is at the center in the X-axis direction and is closer to the positive side in the Y-axis direction than the center in the Y-axis direction. Second coil portion 71b is wound counterclockwise outward from one end 73b. The number of turns of second coil portion 71b is approximately 3 and ⅓ turns. The other end 74b of second coil portion 71b is located at the end of second main surface 52 on the negative side in the Y-axis direction and the negative side in the X-axis direction, and second connection portion 72b is drawn out from the other end 74b. Boundary L2b between the other end 74b and second connection portion 72b is designated by the dot-dot-dash line.

Via electrode 80b that passes through substrate 50 and is electrically continuous with one end 63b of first coil portion 61b is formed at one end 73b of second coil portion 71b. Thus, first coil portion 61b and second coil portion 71b as a whole have a coil shape that is wound counterclockwise from the other end 64b of first coil portion 61b.

In second coil portion 71b, the part enclosed by the dot-dash lines in (b) in FIG. 12 is wide portion 76b, and the other part is narrow portion 75b. Hence, innermost periphery 78b in second coil portion 71b is composed of the inner peripheral edge of innermost narrow portion 75b and the inner peripheral edge of innermost wide portion 76b. Outermost periphery 79b in second coil portion 71b is composed of the outer peripheral edge of outermost narrow portion 75b and the outer peripheral edge of outermost wide portion 76b. The contour of second coil portion 71b includes innermost periphery 78b, outermost periphery 79b, and boundary L2b. This contour is referred to as second coil region R2b. In (b) in FIG. 12, first coil region R1b of first wiring 60b is designated by the dash lines.

As illustrated in (b) in FIG. 12, innermost periphery 68b of first wiring 60b and innermost periphery 78b of second wiring 70b coincide with each other over the whole circumference in a plan view (i.e. as seen in the Z-axis direction). Moreover, outermost periphery 69b of first wiring 60b and outermost periphery 79b of second wiring 70b coincide with each other over the whole circumference in a plan view. Since innermost peripheries 68b and 78b coincide with each other over the whole circumference and outermost peripheries 69b and 79b coincide with each other over the whole circumference, the linear expansion coefficient of first coil portion 61b and second coil portion 71b is made uniform.

### Variation 3

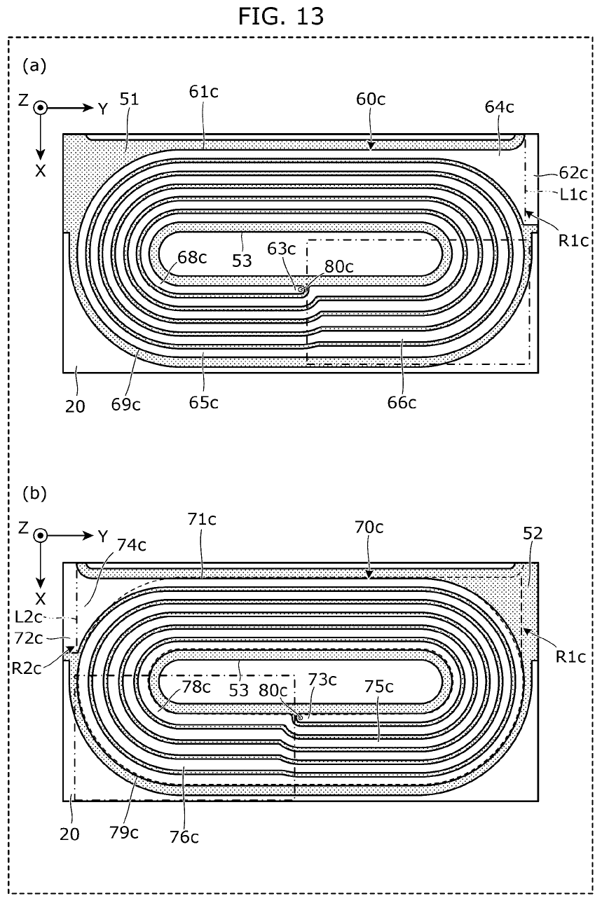

Variation 3 of the foregoing embodiment will be described. Variation 3 differs from the foregoing embodiment and Variations 1 and 2 in the shapes of the first coil portion and second coil portion. FIG. 13 is an explanatory diagram illustrating the planar shapes of first wiring 60c and second wiring 70c according to Variation 3. FIG. 13 corresponds to FIG. 4.

As illustrated in (a) in FIG. 13, first coil portion 61c in first wiring 60c has one end 63c at a position on first main surface 51 that is at the center in the Y-axis direction and is closer to the positive side in the X-axis direction than the center in the X-axis direction. First coil portion 61c is wound clockwise outward from one end 63c. The number of turns of first coil portion 61c is approximately 5 and ¾ turns. The other end 64c of first coil portion 61c is located at the end of first main surface 51 on the positive side in the Y-axis direction and the negative side in the X-axis direction, and first connection portion 62c is drawn out from the other end 64c. Boundary L1c between the other end 64c and first connection portion 62c is designated by the dot-dot-dash line.

In first coil portion 61c, the part enclosed by the dot-dash lines in (a) in FIG. 13 is wide portion 66c, and the other part is narrow portion 65c. Hence, innermost periphery 68c in first coil portion 61c is composed of the inner peripheral edge of innermost narrow portion 65c and the inner peripheral edge of innermost wide portion 66c. Outermost periphery 69c in first coil portion 61c is composed of the outer peripheral edge of outermost narrow portion 65c and the outer peripheral edge of outermost wide portion 66c. The contour of first coil portion 61c includes innermost periphery 68c, outermost periphery 69c, and boundary L1c. This contour is referred to as first coil region R1c.

As illustrated in (b) in FIG. 13, second coil portion 71c in second wiring 70c has one end 73c at a position on second main surface 52 that is at the center in the Y-axis direction and is closer to the positive side in the X-axis direction than the center in the X-axis direction. Second coil portion 71c is wound counterclockwise outward from one end 73c. The number of turns of second coil portion 71c is approximately 5 and ¾ turns. The other end 74c of second coil portion 71c is located at the end of second main surface 52 on the negative side in the Y-axis direction and the negative side in the X-axis direction, and second connection portion 72c is drawn out from the other end 74c. Boundary L2c between the other end 74c and second connection portion 72c is designated by the dot-dot-dash line.

Via electrode 80c that passes through substrate 50 and is electrically continuous with one end 63c of first coil portion 61c is formed at one end 73c of second coil portion 71c. Thus, first coil portion 61c and second coil portion 71c as a whole have a coil shape that is wound counterclockwise from the other end 64c of first coil portion 61c.

In second coil portion 71c, the part enclosed by the dot-dash lines in (b) in FIG. 13 is wide portion 76c, and the other part is narrow portion 75c. Hence, innermost periphery 78c in second coil portion 71c is composed of the inner peripheral edge of innermost narrow portion 75c and the inner peripheral edge of innermost wide portion 76c. Outermost periphery 79c in second coil portion 71c is composed of the outer peripheral edge of outermost narrow portion 75c and the outer peripheral edge of outermost wide portion 76c. The contour of second coil portion 71c includes innermost periphery 78c, outermost periphery 79c, and boundary L2c. This contour is referred to as second coil region R2c. In (b) in FIG. 13, first coil region R1c of first wiring 60c is designated by the dash lines.

As illustrated in (b) in FIG. 13, innermost periphery 68c of first wiring 60c and innermost periphery 78c of second wiring 70c coincide with each other over the whole circumference in a plan view (i.e. as seen in the Z-axis direction). Moreover, outermost periphery 69c of first wiring 60c and outermost periphery 79c of second wiring 70c coincide with each other over the whole circumference in a plan view. Since innermost peripheries 68c and 78c coincide with each other over the whole circumference and outermost peripheries 69c and 79c coincide with each other over the whole circumference, the linear expansion coefficient of first coil portion 61c and second coil portion 71c is made uniform.

In the foregoing embodiment and Variations 1, 2, and 3, the relationship 1.15< (the line width of the wide portion)/(the line width of the narrow portion)<2.1 is satisfied. As a result of this relationship being satisfied, the line widths of the narrow portion and the wide portion can be well-balanced. The wide portion is preferably provided for at least ½ turns.

### Variation 4

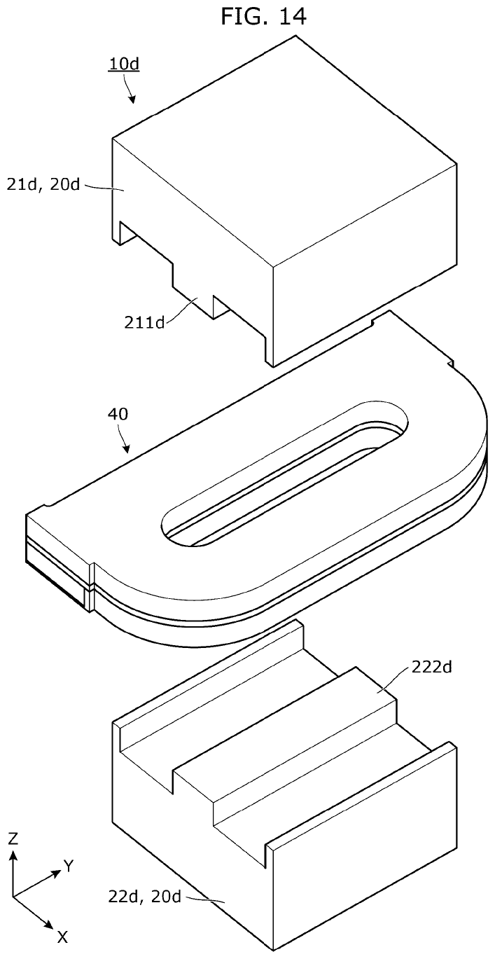

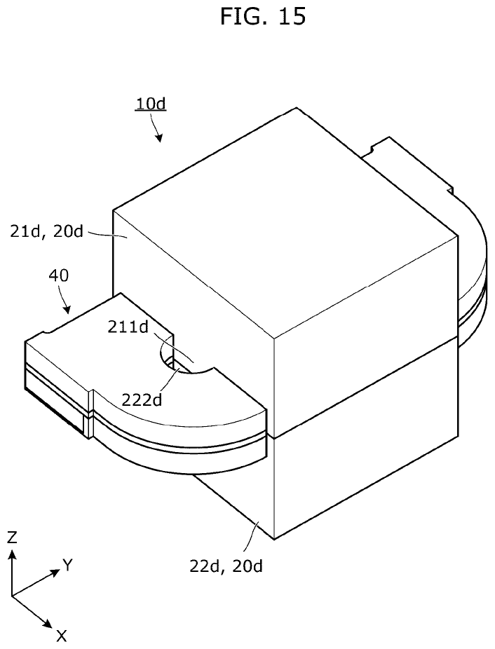

Variation 4 of the foregoing embodiment will be described. The foregoing embodiment describes magnetic core 20 obtained by mixing a magnetic powder and a resin powder and pressure-forming the mixture, as an example. Variation 4 describes an inductor including a block-shaped magnetic core. FIG. 14 is an exploded perspective view of inductor 10d according to Variation 4. FIG. 15 is a perspective view of inductor 10d according to Variation 4.

As illustrated in FIGS. 14 and 15, inductor 10d according to Variation 4 includes magnetic core 20d composed of a pair of magnetic blocks 21d and 22d. Magnetic blocks 21d and 22d are each a block body, and respectively have protrusions 211d and 222d that are inserted into through hole 41 of coil substrate 40. When magnetic blocks 21d and 22d are attached to coil substrate 40 and magnetic core 20d is assembled, the center of coil substrate 40 in the Y-axis direction is covered with magnetic core 20d and both ends of coil substrate 40 in the Y-axis direction are exposed from magnetic core 20d. In this way, at least part of coil substrate 40 is contained in magnetic core 20d.

### Variations 5 and 6

The foregoing embodiment describes an example in which first coil portion 61 and second coil portion 71 are symmetrical in the Z-axis direction as illustrated in (c) in FIG. 7. However, the first coil portion and the second coil portion may be rotationally symmetrical or asymmetrical in a cross-sectional view as long as their occupancy rates are equal.

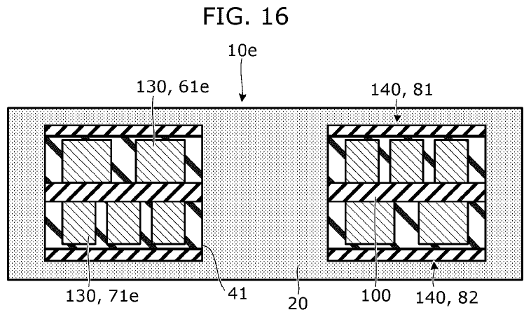

FIG. 16 is a cross-sectional view of inductor 10e according to Variation 5. A via electrode is omitted in FIG. 16. In inductor 10e, first coil portion 61e and second coil portion 71e are equal in occupancy rate and are rotationally symmetrical in a cross-sectional view, as illustrated in FIG. 16.

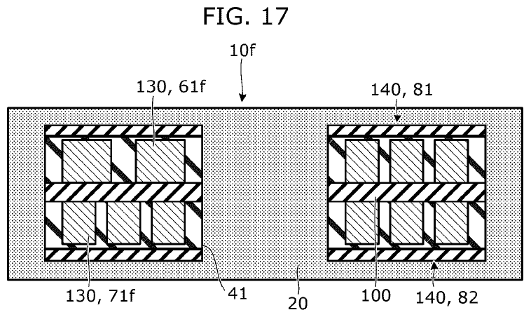

FIG. 17 is a cross-sectional view of inductor 10f according to Variation 6. A via electrode is omitted in FIG. 17. In inductor 10f, first coil portion 61f and second coil portion 71f are equal in occupancy rate and are asymmetrical in a cross-sectional view, as illustrated in FIG. 17.

### Other Embodiments, Etc

While the magnetic materials and the like according to an embodiment of the present disclosure have been described above, the present disclosure is not limited to such an embodiment.

Examples of the inductor described above include inductance components such as high-frequency reactors, inductors, and transformers.

The foregoing embodiment describes substrate 50 formed of an insulating film as an example, but the substrate may be formed of an insulating rigid plate of glass epoxy or the like. This is preferable because the substrate resists deformation when a through hole is formed all at once by pressing during manufacture.

The present disclosure is not limited to these embodiments. Other modifications obtained by applying various changes conceivable by a person skilled in the art to the foregoing embodiment and any combinations of the structural elements in different embodiments without departing from the scope of the present disclosure are also included in the scope of one or more aspects.

### INDUSTRIAL APPLICABILITY

The present disclosure can be applied to, for example, an inductor included in a power supply device.

### REFERENCE SIGNS LIST

10, 10d, 10e, 10f inductor
20, 20d magnetic core
21d, 22d magnetic block
31 first electrode
32 second electrode
40 coil substrate
41 through hole
50 substrate
51 first main surface
52 second main surface
53 opening
60, 60a, 60b, 60c first wiring
61, 61a, 61b, 61c, 61e, 61f first coil portion
62, 62a, 62b, 62c first connection portion
63, 63a, 63b, 63c one end
64, 64a, 64b, 64c other end
65, 65a, 65c, 67, 67a narrow portion
66, 66a, 66c wide portion
68, 68a, 68b, 68c innermost periphery
69, 69a, 69b, 69c outermost periphery
70, 70a, 70b, 70c second wiring
71, 71a, 71b, 71c, 71e, 71f second coil portion
72, 72a, 72b, 72c second connection portion
73, 73a, 73b, 73c one end
74, 74a, 74b, 74c other end
75, 75b, 75c, 77 narrow portion
76, 76b, 76c wide portion
78, 78a, 78b, 78c innermost periphery
79, 79a, 79b, 79c outermost periphery
80, 80a, 80b, 80c via electrode
81 first insulator
82 second insulator
100 substrate
101 through hole
110 seed layer
120, 150, 160, 180 resist layer
130, 170 conductive layer
140 coverlay film
141 adhesive layer
142 insulating film
211d protrusion
222d protrusion
L1, L1a, L1b, L1c, L2, L2a, L2b, L2c boundary
R1, R1a, R1b, R1c first coil region
R2, R2a, R2b, R2c second coil region

1. An inductor comprising:
a coil substrate;
a magnetic core that contains at least part of the coil substrate; and
a first electrode and a second electrode that are connected to the coil substrate,
wherein the coil substrate includes:
a substrate;
a first wiring provided on a first main surface of the substrate;
a second wiring provided on a second main surface of the substrate opposite to the first main surface;
a first insulator provided on the first main surface and covering the first wiring; and
a second insulator provided on the second main surface and covering the second wiring,
the first wiring includes a first coil portion wound outward from one end, and a first connection portion drawn out from the other end of the first coil portion and connected to the first electrode,
the second wiring includes a second coil portion wound outward from one end, and a second connection portion drawn out from the other end of the second coil portion and connected to the second electrode, the one end of the second coil portion being electrically connected to the one end of the first coil portion, and
an innermost periphery of the first coil portion and an innermost periphery of the second coil portion coincide with each other over whole circumference, and an outermost periphery of the first coil portion and an outermost periphery of the second coil portion coincide with each other over whole circumference.

2. The inductor according to claim 1,
wherein the first coil portion and the second coil portion each include a narrow portion having a predetermined line width and a wide portion having a line width greater than the line width of the narrow portion, and
the following relationship is satisfied:
1.15<(the line width of the wide portion)/(the line width of the narrow portion)<2.1.

3. The inductor according to claim 1,
wherein the substrate is formed of an insulating film.

4. The inductor according to claim 1,
wherein the first insulator and the second insulator are each formed of a coverlay film.

5. A method of manufacturing the inductor according to claim 1, the method comprising:
forming the first wiring and the second wiring on the first main surface and the second main surface of the substrate respectively;
forming the first insulator and the second insulator to cover the first wiring and the second wiring respectively; and
forming a through hole in the substrate.

6. A coil substrate that is at least partly contained in a magnetic core in a state of being connected to a first electrode and a second electrode, the coil substrate comprising:
a substrate;
a first wiring provided on a first main surface of the substrate;
a second wiring provided on a second main surface of the substrate opposite to the first main surface;
a first insulator provided on the first main surface and covering the first wiring; and
a second insulator provided on the second main surface and covering the second wiring,
wherein the first wiring includes a first coil portion wound outward from one end, and a first connection portion drawn out from the other end of the first coil portion and connected to the first electrode,
the second wiring includes a second coil portion wound outward from one end, and a second connection portion drawn out from the other end of the second coil portion and connected to the second electrode, the one end of the second coil portion being electrically connected to the one end of the first coil portion, and
an innermost periphery of the first coil portion and an innermost periphery of the second coil portion coincide with each other over whole circumference, and an outermost periphery of the first coil portion and an outermost periphery of the second coil portion coincide with each other over whole circumference.

7. A coil substrate that is connected to a first electrode and a second electrode, the coil substrate comprising:
a substrate;
a first wiring provided on a first main surface of the substrate;
a second wiring provided on a second main surface of the substrate opposite to the first main surface;
a first insulator provided on the first main surface and covering the first wiring; and
a second insulator provided on the second main surface and covering the second wiring,
wherein the first wiring includes a first coil portion wound outward from one end, and a first connection portion drawn out from the other end of the first coil portion and connected to the first electrode,
the second wiring includes a second coil portion wound outward from one end, and a second connection portion drawn out from the other end of the second coil portion and connected to the second electrode, the one end of the second coil portion being electrically connected to the one end of the first coil portion, and
an innermost periphery of the first coil portion and an innermost periphery of the second coil portion coincide with each other over whole circumference, and an outermost periphery of the first coil portion and an outermost periphery of the second coil portion coincide with each other over whole circumference.
